(19) United States
(12) Patent Application Publication
(10) Pub. No.: US 2007/0260491 A1
(43) Pub. Date: Nov. 8, 2007

(54) System for delivery and monitoring of administration of controlled substances

(76) Inventors: Pamela Palmer, San Francisco, CA (US); Thomas Schreck, Portola Valley, CA (US); Andrew I. Poutiatine, San Anselmo, CA (US)

Correspondence Address: DLA Piper Rudnick Gray Cary LLP, Suite 800, 153 Townsend Street, San Francisco, CA, 94107-1957, US

(21) Appl. No.: 11/429,904

(22) Filed: May 8, 2006

(51) Int. Cl. G06Q 50/00

(52) U.S. Cl. 705/3

(57) ABSTRACT

A system is provided for delivery and monitoring the administration of controlled substances which includes one or more databases including a national database of controlled substance users, a database including physician/pharmacy information, a controlled substance delivery device and a docking station for use together with a network and software for communication between the various components of the system.

### FIELD OF THE INVENTION

The present invention relates to systems for administration and monitoring of controlled substances, which includes an information network, a national database of controlled substance users, one or more additional databases, and a drug delivery device. The system provides a variety of mechanisms for monitoring the administration and use of controlled substances with the ability to adjust administration parameters based on input from qualified medical personnel.

### BACKGROUND OF THE TECHNOLOGY

Currently, delivery and tracking of the administration of controlled substances in both the in-patient and out-patient setting have clear limitations with regard to both safety and the potential for abuse.

Controlled drug delivery technology represents an area of active research and controlled drug delivery systems offer numerous advantages as compared to conventional dosage forms, which include improved efficacy, reduced toxicity, improved patient compliance and convenience, as well as minimizing the potential for abuse.

U.S. Patent Publication No. 20060031099 discloses methods for the administration of pharmaceutical compositions using inkjet-based drug delivery devices and a healthcare system that provides for transfer of information from one or more healthcare nodes of the system to a “smart device”. The system enables real-time synchronization of data and records with the drug-delivery device and other healthcare nodes, such as medical professionals, computer systems, fluid reservoirs, or medical devices, such that computer systems within the healthcare system have up to date information for generating instructions for the administration of a drug, making decisions regarding the health of a patient, and creating a health history for the patient for later analysis.

U.S. Patent Publication No. 20060026035 discloses a computer aided interactive medical management information and control system and methods including one or more devices and a computing platform and associated software that assists a health care provider in performing treatment on a patient.

U.S. Pat. No. 6,914,668 discloses a personal identification and security system including a personal identification verification system (such as a biometric information comparison system), a controlled substance detection and identification system (such as a spectroscopic detection and identification system) and an alarm indicator.

U.S. Pat. No. 6,762,684 discloses a processor implemented monitoring system which includes a sensor coupled to the processor for sampling a physiological parameter of a subject such as a unique identification parameter of a subject heart function, e.g. blood pressure, pulse, blood oxygen level, as well as unique subject, i.e., identifying physiological parameters such as DNA characteristics obtained from sampling of blood or other fluids such as saliva, perspiration, etc., a retinal scan, a fingerprint scan, voice recognition and the like, coupled with a location ascertaining system, e.g. a GPS system. The mobile unit is coupled via radio, cellular telephone or other wireless or wired communications link with a central station and can transmit information pertaining to the condition as well as the location of the subject.

U.S. Patent Publication No. 20050049464 discloses a wireless communication system that includes a remote pharmaceutical administration device for monitoring the vital signs of a patient, an analysis processor for receiving the vital signs, a transceiver for transmitting the vital signs over a wireless network and receiving an action plan over the network, and an administration means for administering a prescribed medication to the patient.

U.S. Patent Publication No. 20050054942 discloses systems and methods for monitoring therapeutic drug concentration in the blood by detecting markers, upon exhalation by a patient after the drug is taken, using electronic sensor technology and a reporting system.

U.S. Pat. No. 6,824,512 (Medtronic, Inc.) discloses a closed loop system for monitoring drug dose, intake and effectiveness which includes a pill dispenser in communication with at least one implantable medical device. The system includes high speed computers and databases relating to patient history and device information.

U.S. Pat. No. 6,190,326 discloses a system for collecting patient respiratory information which includes a base unit and a removable mouthpiece.

U.S. Pat. No. 6,039,251 discloses a method and system for controlling an in-home medical device, such as a drug delivery pump, wherein a control program or “prescription” for control of the device is encoded on a portable card. Data relating to the device can be saved to the card, and a security program is provided which ensures that only authorized patients can use the medical device. Remote access to the medical device is provided through a communication system between the controller for the medical device and a remotely located computer.

U.S. Pat. No. 5,752,620 discloses a pill dispenser, comprising a container constructed to hold a plurality of pills, with a pill release mechanism provided to dislodge the pill from the pill holder by pneumatic pressure and sensors located on the exit port to detect the presence of a dispensed pill, which is recorded by an attached computer. Optionally, a locking device is attached to the pill dispensing unit to prevent unauthorized dispensation of medication.

U.S. Pat. No. 5,710,551 discloses a system for the remote monitoring of in-home self-medication to assure compliance with prescribed dosage schedules.

U.S. Pat. No. 5,945,651 discloses a medication dispensing system including a relatively small, microprocessor-controlled machine that assists in the accurate execution of a physician-prescribed medication regimen. The machine can be used as a stand-alone unit, or can be integrated into a centrally-controlled pharmaceutical network.

U.S. Pat. No. 5,995,938 discloses a medication compliance system having an output device and a computer in communication with the output device for use in printing a label.

The related art does not disclose or suggest systems for delivery and monitoring of the administration of controlled substances. Although a number of references mention the concept of computer monitoring or control of drug delivery, for example, an “electronic pill box” and the like, the current invention provides a number of features not taught or suggested by systems currently known in the art.

Also not found in the relevant art is a drug delivery device (that does not require the opening and closing of a lid or other hinged aperture) for drug delivery dosage forms, wherein the device includes the features that contribute to the current invention, namely, a drug reservoir, a lock out feature and a means of communication with a computer network, i.e. via a docking system.

There is a need for a drug delivery system that provides for improved safety and efficacy while eliminating or minimizing potential for abuse including for example: a security feature that prevents unauthorized access to stored drug, a lock-out feature, a dose counting feature, a memory means for retaining information about dose delivery, and an interface for exchanging information with another device such as a computer/information network.

There is therefore, substantial interest in the development of systems for drug delivery, more specifically administration of controlled substances, in both the hospital and out-patient setting.

### SUMMARY OF THE INVENTION

The invention provides computer aided systems and methods for delivery and monitoring of controlled substances. The systems include a drug delivery device. Information from the drug delivery device can be communicated via a computer network to one or more databases. The drug delivery device may communicate by way of a docking station, wherein the docking station provides a connection to a computer network and information is transmitted bidirectionally between the drug delivery device and a computer network, for example, a wireless computer network.

More specifically, the systems include: (a) an information network comprising a computing platform and software comprising a search mechanism running on the computing platform; (b) at least one information storage device connectable to the computing platform for storing the software; (c) one or more databases for storing patient usage information and prescription information for at least one controlled substance; (d) at least one device for administering a controlled substance to a patient connectable to the information network for transmission of patient usage information to the information network; and (e) a communications interface for establishing a bidirectional communication link to at least one external source.

The prescription information includes information regarding the patient and is stored in a national database of controlled substance users. The national database of controlled substance users is in compliance with the Health Insurance Portability and Accountability Act (HIPAA) regulations and provides coded or encrypted patient information to avoid misuse of information or inappropriate access.

In using the system, prescription information for at least one controlled substance is entered into the information network by a registered user.

The system provides for a search of the national database and a software generated alert when a search of the national database indicates that prescription information for more than one controlled substance has been entered into the national database for the same patient during the same time period or when a search of the national database indicates the possibility of a drug-drug interaction. The system provides a means for the alert to be transmitted to the prescribing physician and registered user who entered the information by way of an email, a text message, a page, a phone call or other communication.

The system also provides a means for a drug delivery device for administering the controlled substance to a patient to be connected to the information network by way of a docking station using a connection selected from the group consisting of a computer (i.e., a USB port), a removable card (or other media), a phone line, or a wireless connection. When docking occurs, patient usage information is transmitted to the information network and stored in at least one database.

The system further provides for collection of information on biological parameters of the patient using a docking station. The information on biological parameters of the patient may include pain score, anxiety score, insomnia score, temperature, pulse, blood pressure, respiratory rate, oxygen saturation, blood chemistry and bodily fluid chemistry information.

The device for administering a controlled substance typically includes a detection mechanism for patient identification such as an RFID tag, a password, a pass code, fingerprint information, optical information, voice recognition, facial recognition or the results from DNA analysis of a bodily fluid sample.

Verification of patient identification may be required on a daily, monthly or other basis, in order for the device to remain activated. The frequency at which verification is required determined and may be adjusted by the prescribing physician.

The system may further include at least one input device for manual entry of information into the system by a registered user by way of a microphone, a touch screen, a keyboard, or a graphical input device.

The system provides for manual entry of prescription information and changes in prescription information. Such manual entry may occur in response to an alert or for other reasons.

Information may be transmitted to, from and within the system by way of a telephone, an Internet connection, a WAN network connection, a LAN network connection, a wireless connection or a satellite connection.

In using the system, a controlled substance is loaded into a device for administering a controlled substance and dispensed to a patient when no alert is generated by the system and the device is initially activated following verification of patient identity.

The patient may self-administer the controlled substance when the device for administering a controlled substance is in an activated state.

### DESCRIPTION OF THE DRAWINGS

FIG. 1 is a schematic depiction of the functional elements of the controlled substance delivery and monitoring system of the invention, which include a registered user and/or prescribing physician, also termed “qualified medical personnel” [1], who has received training in use of the system by the office of the prescribing physician and who enters the prescription (Rx) information into the computer systems such that it is transmitted to a national database of controlled substance users [2] containing an index of users and Rx information; the system then provides a double check for other prescriptions and the identity of the patient. When a patient brings a prescription for a controlled substance to a pharmacy, the pharmacist [3] double checks the Rx information and initial patient information in the system The initial patient information is stored in a national database of controlled substance users, which is automatically searched for accuracy and other parameters when a patient brings a prescription to a pharmacy to be filled. The system software checks for other controlled substance prescriptions for the same patient and for drug-drug interactions. If the prescription information is accurate and no drug-drug interaction detected, a controlled substance delivery device [4] is filled with the prescribed medication, is dispensed, then docked with a docking station [5], and information is bidirectionally transmitted between the information network and the device via the docking station. In most cases, then the patient identity is verified and the controlled substance delivery device is unlocked (activated) [6] and ready for use. Alternatively, if a problem is detected with the prescription information or a drug-drug interaction detected, an alert is initiated and sent via the information network to a physician database [7], the registered user who input the prescription information and the prescribing physician. The activated delivery device [6] is used to deliver medication to the patient [8] in a controlled manner. Both the national database of controlled substance users and physician database are part of an information network which receives and sends information to the controlled substance delivery device by way of a docking station. In addition, information may be transmitted bidirectionally between the information network to the patient's chart [9]. A* indicates a step where an alert may be generated. Typically, the docking station is at a physician's office, a pharmacy and/or the patient's home.

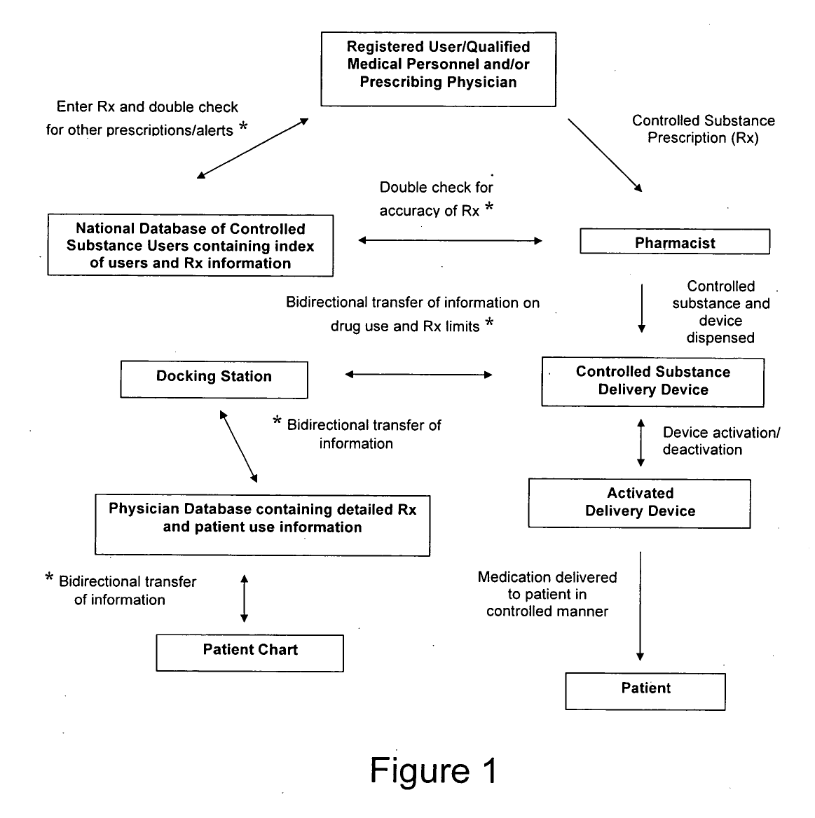

### DETAILED DESCRIPTION OF THE INVENTION

The following disclosure describes the systems and methods which constitute the invention. A detailed disclosure of the systems and methods of the invention for the delivery of controlled substances is provided herein.

The controlled substance delivery and monitoring system of the invention is not limited to specific controlled substances, formulations, dosages forms, delivery devices, or methods of use. As such, the systems and methodology for treatment of the medical condition of the patient described herein, may, of course, vary. It is also to be understood that the terminology used herein is for the purpose of describing particular embodiments only, and is not intended to limit the scope of the present invention.

It must be noted that as used herein and in the appended claims, the singular forms “a”, “and”, and “the” include plural references unless the context clearly dictates otherwise. Thus, for example, reference to “a drug formulation” includes a plurality of such formulations and reference to “a drug delivery device” includes systems comprising drug formulations and devices for containment, storage and delivery of such formulations.

Unless defined otherwise, all technical and scientific terms used herein have the same meaning as commonly understood to one of ordinary skill in the art to which this invention belongs. Although any methods, devices and materials similar or equivalent to those described herein can be used in the practice or testing of the invention, the preferred methods, devices and materials are now described.

All publications mentioned herein are incorporated herein by reference for the purpose of describing and disclosing the compositions and methodologies which are described in the publications which might be used in connection with the presently described invention. The publications discussed herein are provided solely for their disclosure prior to the filing date of the present application. Nothing herein is to be construed as an admission that the invention is not entitled to antedate such a disclosure by virtue of prior invention.

Definitions

The term “controlled substance” as used herein is used with reference to drugs, the prescription and administration of which is highly regulated. In general, “controlled substances” are listed in Schedules I through V in the United States. Schedule I drugs are not often used medically and Schedule V drugs have a very low risk of abuse, therefore the drugs most highly in need of controlled access are included in Schedules II, III and IV. Outside the United States (i.e. in Canada, Europe and Japan), the term “controlled substance” is used with reference to any drug that is legally regulated by the government based on risk of misuse and/or abuse.

The term “formulation” or “drug formulation” or “dosage form” as used herein refers to a physical entity containing at least one therapeutic agent, i.e., a controlled substance, meant for delivery to a subject. It may be in the form of a lozenge, pill, capsule, gel cap, membrane, strip, liquid, patch, film, gel, spray or other form.

The term “drug” as used herein is generally meant to refer to any substance that alters the physiology of an animal.

The term “drug” may be used interchangeably herein with the term “therapeutic agent” or “medication”. It will be understood that a “drug” formulation of the invention may include more than one therapeutic agent, wherein exemplary combinations of therapeutic agents include a combination of two or more compounds, wherein one or more of the combined compounds may be a controlled substance. The term “congener” as used herein refers to one of many variants or configurations of a common chemical structure.

The term “subject” is includes any subject, generally a mammal (e.g., human, canine, feline, equine, bovine, ungulate etc.), in which treatment for a disorder, such as management of pain or anxiety, is desired.

The term “drug delivery route”, as used herein refers to any means for delivering a drug to a patient. Exemplary routes include, but are not limited to, subcutaneous, intramuscular, intravenous, transdermal, transmucosal, oral (i.e. via the GI tract), intrathecal and epidural.

The term “transmucosal” delivery of a drug and the like is meant to encompass all forms of delivery across or through a mucous membrane. Examples of “transmucosal” delivery include, but are not limited to delivery via the oral, nasal, buccal, ocular, vaginal, and rectal mucosa. In particular, “oral transmucosal” delivery of a drug includes delivery across any tissue of the mouth, pharynx, larynx, trachea, upper respiratory tract or upper gastrointestinal tract, particularly including the sublingual, gingival and palatal mucosal tissues.

The term “therapeutically effective amount” means an amount of a therapeutic agent, or a rate of delivery of a therapeutic agent (e.g., amount over time), effective to facilitate a desired therapeutic effect, such as pain relief. The precise desired therapeutic effect (e.g., the degree of pain relief, and source of the pain relieved, etc.) will vary according to the condition to be treated, the tolerance of the subject, the drug and/or drug formulation to be administered, e.g., the potency of the therapeutic agent (drug), the concentration of drug in the formulation, and the like, and a variety of other factors that are appreciated by those of ordinary skill in the art. In one exemplary embodiment, the systems and methods of the invention find utility in the suppression or mitigation of pain in a subject suffering from pain that may be associated with any of a variety of identifiable or unidentifiable etiologies.

The term “treatment” or “management” of pain is used herein to generally describe regression, suppression, or mitigation of pain so as to make the subject more comfortable as determined by subjective criteria, objective criteria, or both.

The term “qualified medical staff” or “qualified medical personnel” as used herein refers to a person who has been authorized to have access to computer network of the controlled substance administration and monitoring system of the invention. Persons who are authorized to have access to computer network must undergo training for use of the system and HIPAA compliance. Once trained, system users are given a user ID before they are given password protected access to the database and become a “registered user” or “authorized user”. The user ID links the authorized person to the prescribing physician and is used to track all activities by the user relative to the controlled substance administration and monitoring system of the invention.

“Device for containing and delivering a controlled substance dosage form ” or “drug delivery device” and the like are used herein to refer to any device adapted for storage and/or delivery of a controlled substance formulation such as a nanotab, pill, tablet, lozenge, gel, liquid, strip, film, spray, mist and the like.

“Operatively connected” as used herein means the components are provided in a device so as to function as intended to achieve an aim. For example, a memory device operatively connected to a CPU which is further operatively connected to a release mechanism or sensor may be meant to indicate that, upon actuation, the CPU communicates with the memory device to check the status or history of drug delivery, and then further communicates with the release mechanism (e.g., via a solenoid and a switch) to release and deliver a drug.

The term “network” as used herein typically refers to computer network that spans a large geographical area. Typically, a WAN consists of two or more local-area networks (LANs). Computers connected to a wide-area network are often connected through public networks, such as the telephone system. They can also be connected through leased lines or satellites. The largest WAN in existence today is the Internet. The term “wired network” as used herein refers to a network that relies on communication via a wired system or network such as the telephone or cable system.

The term “wireless network” as used herein refers to communication via a system or network, without the need for a wired connection. A wireless network may consist of, but is not limited to, the following wireless technologies: wireless telephone, radio frequency, infra red, laser, optical light, or specific wireless communication protocols such as Bluetooth, 802.11, or any other wireless communication protocol.

“Radio Frequency Identification (RFID)” refers to an automatic identification method, which relies on storing and remotely retrieving data using devices called RFID tags or transponders. An RFID tag is a small object that can be attached to or incorporated into a product, animal, or person. RFID tags contain silicon chips and antennas to enable them to receive and respond to radio-frequency queries from an RFID transceiver.

“Sustained drug delivery” refers to release or administration of drug from a source (e.g., a drug formulation) over a protracted period of time, for example, over a period of a minute or more. Sustained drug delivery is in effect the opposite of bolus drug delivery.

The term “active agent” is used herein to refer to any therapeutically active agent.

The term “drug delivery device” means a device that delivers controlled substance dosage forms, which carry a dose of medication to the patient. The controlled substance dosage form delivery device is useful for controlled and safe delivery of the drug.

The term “system that includes a controlled substance dosage form and delivery device” as used herein refers to a system for delivery of a controlled substance dosage form and control and monitoring of both efficacious, as well as maximum and minimum doses such that the amount of controlled substance (drug) delivered and the corresponding efficacy and safety are enhanced over currently available systems.

The term “opioid tolerant patient” as used herein means a physiological state characterized by a decrease in the effects of an opioid substance (e.g., analgesia, nausea or sedation) with chronic administration. An opioid substance is a drug, hormone, or other chemical substance that has analgesic, sedative and/or narcotic effects similar to those containing opium or its derivatives. If analgesic tolerance develops, the dose of opioid substance is increased to result in the same level of analgesia. This tolerance may not extend to side effects and side effects may not be well tolerated as the dose is increased.

The term “opioid naive patient” is used herein with reference to a patient who has not received repeated administration of an opioid substance over a period of weeks to months.

The term “acute pain” is used herein with reference to pain that is typically present for less than one month, however, in some cases pain that is present for as long as three months may also be considered to be “acute”.

The term “chronic pain” is used herein with reference to pain that is typically present for longer than one month.

### GENERAL FEATURES OF THE INVENTION

The present invention encompasses systems and methods for the administration and monitoring of a controlled substance which is effected and monitored using a drug delivery device, a means for the device to communicate with a computer network station or wireless communication protocol, e.g., by way of a docking station, a communication component for monitoring the physical state of the patient by measurement of one or more biological parameters, and transmitting drug delivery information and the biological parameter(s) of the patient to a network such that an alert is sent to qualified medical personnel if there is a problem (e.g., drug dosing outside of prescribed limits) and the drug dose is adjusted as needed. An “alert” may be manually generated or may be automatically generated by the software of the computer system of the system of the invention. In either case, an alert causes an email, text message, page, phone call or other communication to be sent to the system user who entered the information into the database relative to the relevant prescription or controlled substance user and to the prescribing physician.

The present invention is directed to a system for delivery and monitoring delivery of controlled substance(s), wherein the system includes a National Database of controlled substance users, i.e., AcelRx™ device users. A delivery device, e.g., an AcelRx™ device is used to administer a controlled substance or drug to a patient, as described for example in U.S. Application Ser. No. 60/756,937, expressly incorporated by reference herein in its entirety.

In using the system of the invention, the prescribing physician or a person authorized by the prescribing physician (referred to herein as an “authorized user” or “registered user”) will log into the computer network and enter the prescription information into a National Database of controlled substance users. The prescription information will include the patient's name, age, address, phone number, emergency contact, social security number or other unique identifier. Regarding the drug, the name, dose and quantity of dosage units of the controlled substance, and the name of the prescribing physician is entered. When a pharmacist receives a prescription for a controlled substance or drug, that is requested to be prescribed with a controlled substance delivery device such as an AcelRx™ delivery device, the pharmacy staff will verify that the drug being given to the patient matches the “initial National Database information” which includes the patient's name and other identifying information, as well as the drug name, quantity and prescribed dosage which is verified relative to the information in the National Database. The pharmacy staff will then enter the pharmacy information, such as the name of the pharmacy, address, pharmacists name, drug expiration date and the pill count if different from the prescribed amount. This is important because often pharmacies don't have enough controlled drugs in stock to completely fill a prescription and information relative to dispensing of a partial prescription is therefore entered into the database. The “prescribing information” as described above will be entered into the computer system by a person authorized by the prescribing physician (i.e., a “registered user”) and verified by the person dispensing the medication every time the prescription is refilled. Any changes in patient identifiers will be updated in the computer by authorized staff at the prescribing physician's office (i.e., a “registered user”). Drug delivery devices such as an AcelRx™ devices is docked at the pharmacy prior to dispensing in order to have the prescribing information downloaded into the device. In addition to the drug information listed above, lock-out times and docking times prescribed by the physicians are also downloaded into the device software.

Data may be entered into the information network using at least one input device, for example, a microphone, a touch screen, a keyboard, or a graphical input device.

The system of the present invention for delivery and monitoring of controlled substance(s), comprises software, i.e., AcelRx™ software which provides a number of features. One such feature is that addition of a patient name or other identifier to the National Database, triggers the software to automatically conduct a search to see if the same patient is receiving scheduled drugs from another prescriber/pharmacy. The search is conducted on a national level. The system will generate an alert based on a number of parameters. For example, if a controlled substance has been prescribed for the same patient name, same address or same unique identifier at more than one location, an alert will be issued. If the pharmacist enters drug information that does not match the entered prescribing information from the physician's office, an alert will be issued. Current systems that track users of controlled substances are state specific or pharmacy-chain specific and are delayed regarding feedback and have no direct alerts for prescribing and dispensing mismatches. Also, such systems do not allow for a nationwide tracking of the use of controlled substance. The system of the invention provides a mechanism to track abuse, which is not available using current systems.

In the system of the invention, each dispensing pharmacy also has access to the information network of the system as well as the appropriate software, i.e., AcelRx™ software, such that they are able to search the National Database to confirm that the dispensing information for a given prescription matches the prescribing information entered by the physician.

The system does not require a paper prescription since the system software, i.e., AcelRx™ software can provide a direct link between the physician and the pharmacy.

The National Database is searchable by registered or authorized users using the appropriate software, i.e., AcelRx™ software. The database is Health Insurance Portability and Accountability Act (HIPAA) compliant and provides appropriately ID coded or encrypted patient identifiers to avoid misuse of information/inappropriate access. Users of the controlled substance delivery device and monitoring system of the invention are provided online training for HIPAA compliance. Docking systems are used to download patient information/drug usage to and from the controlled substance delivery device. This can be done in any location where there is a docking station, for example, at a physician's office, at a pharmacy or in the patient's home. In some situations, the docking station is as simple as a data transmission port, i.e. a USB port. In other situations, the docking station is used to measure biological parameters of the patient.

In one aspect, the controlled substance delivery and monitoring system of the invention also includes a “physician” database, which interfaces and can exchange data with the National Database. The Physician Database also provides an interface and data exchange with a local docking system. The patient data on the Physician Database may include all of the data in the National Database and further includes information regarding use of a given controlled substance by each patient (referred to herein as “patient usage information”). Patient usage information may be downloaded/transmitted from the controlled substance delivery device into a database of the system of the invention. The information is typically transmitted from the device to the system by way of a docking station and the data transmission takes place by way of a bidirectional communication network which may be wireless or may include a direct wired or other connection. Such patient usage information includes but is not limited to, device information, drug usage information, such as the name of the drug in the device, dosage, total pill count used over various time frames, lock-out time. Data on other medications the patient is taking concurrently with the controlled substance may be entered by the physician or pharmacy staff and processed by the system software, i.e., AcelRx™ software as well as downloaded to the device.

An “alert” is generated by the system software if a possible drug-drug interaction is detected.

When the device used to deliver the controlled substance is docked, the system may also collect additional information that can be downloaded/transmitted to a database, e.g., the Physician Database of the system of the invention.

Such additional information includes, but is not limited to, one or more biological or physiological parameters such as pain score or other information related to the medical condition for which the controlled drug was prescribed (e.g. sleep score, anxiety score, mood score, etc) temperature, pulse, blood pressure, respiratory rate, oxygen saturation, blood chemistry and/or bodily fluid chemistry information.

The docking system allows for transmission of drug delivery information. The frequency with which the device is docked and information is transmitted to a database, e.g., the Physician Database and reviewed will vary and is controlled by the prescribing physician's office. For example, the device may be docked and information transmitted to the information network at daily, weekly, biweekly, monthly or other interval. An alert will occur to both the patient and the physician's office if the docking interval exceeds what was requested by the physician.

When the device is docked there is a bidirectional flow of information between the computer network of the controlled substance monitoring and administration control system and the drug delivery device. Information that is transmitted from the drug delivery device to the computer network via a docking station includes, but is not limited to: information on use of the device such as number of dosage units delivered, time interval at which they were delivered, number of dosage units remaining in the device, and biometric, PIN or other security access information The frequency at which the device must be docked is programmed into the system by the physician's office. A dock may be designed to measure and transmit biomedical or physiological parameters (e.g. blood oxygen saturation and pulse) and symptom scoring (e.g. pain, anxiety) to the information network.

Information that is transmitted to the drug delivery device and patient dock from the computer network includes: information on allowable use of the device such as number of dosage units to be delivered, time interval at which they can be delivered (lock-out time), frequency of docking necessary, frequency of biometric or PIN ID entry by the patient, etc. Safe limits for the biological parameters that provide information on the physiological status of the patient can be changed as well. For example, if a patient is known to have a chronic respiratory condition and normally has oxygen saturations in the range of 91% then the lower limit of the alert range for oxygen saturation (usually 92-93%) may be programmed lower than 91% for this patient in the system by the physician.

As suggested above, a physician may have the ability to directly reprogram the device such that the new information is transmitted to the device via the docking system in the office during a visit or remotely at the patient's home. Parameters that may be changed include, for example, the unit dose administration lock-out time, the frequency for biometric patient confirmation prior to delivering the medication, frequency of docking that is required for the delivery device to continue to deliver the controlled substance, as well as other information such as battery life, etc.

Software associated with the information network of the system of the invention and accessible at a doctor's office monitors incoming information downloaded/transmitted from the drug delivery device when it is docked. An “alert” is also generated by the system software if a scheduled docking is missed, dosing of the controlled substance is out of the prescribed range, there is evidence that the device has been tampered with or if the device has an empty cartridge, i.e. contains no dosage unit forms (i.e., tablets) of the controlled substance.

Once qualified medical personnel, e.g., in the prescribing physician's office, become aware of the “alert”, office staff contact the patient to determine problem. It follows that the controlled substance administration and monitoring system of the present invention is a closed-loop system.

In one exemplary aspect, the controlled substance drug delivery system of the invention provides for oral transmucosal delivery of controlled substances such as opioids or opioid agonists, for the treatment of acute or break-through pain.

The drug delivery device of a controlled substance dosage form delivery system of the invention has a number of features that provide for improved safety and ease of use over currently available systems including a security feature that prevents unauthorized access to the stored drugs, a lock-out feature, a dose counting feature, a memory means for retaining information about dose delivery, and an interface for bidirectional exchange of information with another device such as a computer.

A given patient may be taking more than one medication, at least one of which is a controlled substance. In one aspect of the invention, such a patient may use two or more controlled substance drug delivery devices, each of which can be docked in a docking station in order to down load drug dispensing information for each drug into the computer system such that the information is stored in the Physician Database. Alternatively, a single controlled substance drug delivery device may be used to deliver more than one medication.

A device for delivery of a controlled substance in conjunction with the system of the invention may be used multiple times or be disposable such that it is discarded when all of the medication initially loaded into the device has been delivered.

A drug delivery device of the controlled substance administration system of the invention has the capacity to store historical device use/drug delivery information and communicate such information with another device or computer such that the data is stored in one or more computer databases. For example, such information may be communicated by downloading stored information to a computer using a physically wired interface, such as a USB or any other communication connection. Alternatively, information may be communicated via a wireless system. Such information may include historical use information, for example the number of dosages stored and delivered, and the times of delivery.

The device may also comprise a means to confirm that the individual attempting to dispense the controlled substance or drug is the patient for which the drug was prescribed, i.e., by way of a detection mechanism for patient identification such as an RFID tag, password, pass code, or biometric identifier, e.g., such as fingerprint information, optical iris information (i.e. a retinal scan), voice recognition, facial recognition (i.e. visual scan image recognition of facial features), or gene or DNA characteristics obtained from a bodily fluid sample. This serves to confirm that the correct patient is receiving the controlled substance or drug and minimizes the possibility for diversion or inappropriate use of the drug.

The physician may mandate that only the patient is allowed to pick-up the controlled substance (drug)/device combination in order to initially activate device for the specific patient. The device may be initially picked up at a pharmacy or be dispensed at a physician's office. A physician may override the requirement for biometric information for use of the device and/or identification may not be required prior to administration of each dose. A physician will determine the frequency of patient identification required.

The device may have colored or other visual, audible, or tactile identifiers to communicate the dosage contained therein.

The drug delivery device may include a microprocessor (CPU) in communication with a memory means and a display means that enables the device to monitor and control dosing, dose frequency, communication, synchronization, user identification, and schedule, and access to the doses and to store programmed and historical information.

In another aspect, the device is adapted to track and communicate the total number of doses remaining in the device to allow anticipation and scheduling of refilling. The device also may record and track drug usage and communicate this, via a wireless network, electronic docking or other means, such that the information is transmitted via a network and accessible by qualified medical personnel, who can monitor the patient's drug use and adjust the dose as needed.

In some embodiments, the device may be remotely programmed to allow oversight by qualified medical personnel and therefore provides a means for management and optimization of the administration of controlled substances. The delivery device may include a radio frequency identification (RFID) system or other remote operation system that provides a unique key for each device that must be proximal to the device for operation, so as to prevent accidental or intentional tampering, abuse, or access to the drug by an unauthorized individual.

The system may be used in such a way as to provide for delivery of an opioid antagonist in conjunction with an opioid and/or an addiction control substance such as buprenorphine, in a configuration that prevents intentional diversion or tampering.

In many cases, the docking station is in a physician's office or other location, such as a pharmacy. In other cases, the system includes a docking station that is in the patient's home. The docking station provides a means for downloading drug delivery information from a controlled substance delivery device. In one approach, a simple feedback loop would not require a patient home-docking unit but rather the device would be queried during physician visits, e.g., every month. At such visits the device, if necessary, could be reprogrammed by the physician as to lock-out time, frequency of biometric ID checks. Since no docking system is at the patient's house, programming the frequency of docking and setting of limits of biomedical parameters would not be necessary. In another approach, more complex feedback loop would include the patient's docking system and would allow real-time reprogramming of the device parameters by the physician. For example, if the physician prescribes a higher-strength tablet, then the physician enters the new information into the National Database, then the patient would take the device to the pharmacy for the new tablets to be dispensed into the device by the pharmacist and the prescription is double-checked with the National Database to assure that no tampering with the prescription has taken place. The device is then reprogrammed by docking the device at the pharmacy and downloading this new prescription data (new pill count, new dosage strength, etc). Therefore, there are various levels of complexity and closed loops depending on the number of docking stations and communication means implemented.

The docking station may include a power supply and provides a means for transmission of drug delivery information from a controlled substance delivery device through the network such that it is recorded in a database, e.g., the Physician's Database. The information may be transmitted through a wireless, local area network (LAN) or wide area network (WAN) to the Internet via the docking station. The docking system can link into an information network by way of a computer, removable card (or other media), phone line, wireless or other connection.

In this way the controlled substance delivery and monitoring systems of the invention enable greater oversight and care management by qualified medical personnel.

Current Systems for Administration of Controlled Substances

Current treatment methods for administration of controlled substances are used for a variety of disorders, including pain management, treatment of anxiety or insomnia, treatment of attention deficit, treatment of opioid addiction, treatment of steroid imbalances and treatment of excessive sedation are all examples.

In the U.S., controlled substances are placed into Scheduled drug categories (I-V). Examples of drugs in these categories include:

Schedule I: heroin, mescaline (drugs not used clinically to treat diseases).

Schedule II: opioids (e.g. morphine, hydromorphone, oxycodone), stimulants (amphetamines), barbiturates (amobarbital, pentobarbital), methylphenidate.

Schedule III: opioids (e.g. hydrocodone, codeine), barbiturates (butalbital), partial opioid agonists (buprenorphine), marinol, methyltestosterone.

Schedule IV: weak kappa agonist opioids (e.g. pentazocine, butorphanol), stimulants (dexfenfluramine, modafinil), benzodiazepines for sleep and anxiety (alprazolam, clonazepam, diazepam, triazolam), barbiturates (phenobarbital), chlordiaxepoxide.

Outpatient Setting

Any of the above examples of controlled substances may be used in the controlled substance delivery system of the invention, also referred to herein as the “AcelRx™ system”, Therefore, it follows that users of the system may suffer from a variety of medical disorders for which the system finds utility. Treatment of acute and chronic pain with opioids is described below as one set of examples, but one skilled in the art will understand that this system may be used to deliver controlled drugs for treatment of anxiety, insomnia, excessive sedation, hormone imbalance, opioid-resistant pain (with the use of ketamine for example), nausea or decreased appetite (with the use of Marinol for example), attention deficit disorder or hyperactive disorders, and various other conditions requiring the use of controlled substances.

Treatment of severe acute and chronic pain is often necessary for patients in an outpatient setting. For example, many patients suffer from chronic pain and require the use of opioids on a weekly or daily basis to treat their pain. While they may have a long-acting oral or transdermal opioid preparations to treat their chronic underlying pain levels, they often need short-acting potent opioids to treat their severe breakthrough pain levels.

Acute and chronic pain also needs to be treated in patients who may have a history of drug abuse and the physician is afraid of prescribing opioids on an outpatient basis. Data from the Drug Abuse Warning Network (DAWN) from 1990-1996 indicate that the abuse of opioid analgesics accounts for 3.8-5.1% of emergency department presentations, yet withholding pain relief to patients with a history of drug abuse is not a viable solution.

In the above clinical settings, there is clearly a need for a system for administration and monitoring of controlled substances which provides for improved safety and efficacy.

Controlled substances may be administered by any of a number of routes including oral, transmucosal (i.e. sublingual, intranasal, buccal, rectal, vaginal), subcutaneous injection, intramuscular injection, transdermal, epidural and intrathecal. Therefore the drug delivery device may be constructed in any of a variety of ways that enable delivery of the various forms in which medications comprising controlled substances are administered. For example, the drug delivery device will vary such that it is able to deliver any of a number of dosage forms, including, but not limited to: pills, sublingual lozenges, patches, suppositories, injectable syringes, sprays, gels, liquids, etc. It will be understood that the delivery route and configuration of the drug delivery device will not affect the bidirectional communication, monitoring and control aspects of the system of the invention.

The oral route of administration is the most widely used route and most acceptable for the patient. Disadvantages of the oral route is that absorption of drugs may be reduced by the delay in gastric uptake, as well as nausea and vomiting. Thus the oral route may be unsuitable in some instances.

The sublingual route offers some theoretical advantages for drug administration. Absorption occurs directly into the systemic circulation as there is no first pass metabolism. This is also true for the intranasal and buccal routes. Rectal or vaginal administration provide useful transmucosal alternatives.

Subcutaneous injection and intramuscular injection represent another technique for delivery of drugs, however this requires invasive access and produces discomfort for the patient and therefore is not highly desirable.

Intravenous administration has been routinely used in the in patient setting, but is rarely used on an outpatient basis due to difficulty in obtain intravenous access and also because opioids, for example, are inherently dangerous if the patient is left unsupervised for even a short period.

### Examples of Use of Controlled Substances

Use of Opioids

Opioids are powerful analgesics and are utilized to treat both acute and chronic pain of moderate to severe intensity throughout the world. However, they can also have severe respiratory depressive effects if not used appropriately and suffer from a high abuse potential. In 1998, a total of 36,848 opiate exposures (pure and mixed preparations) were reported to US poison control centers, of which 1227 (3.3%) resulted in major toxicity and 161 (0.4%) resulted in death. The predominant cause of morbidity and mortality from pure opioid overdoses is via respiratory complications.

Opioids are still widely used for the treatment of pain, and are generally delivered via numerous routes of administration, including but not limited to intravenously, orally, transmucosally, epidurally, intrathecally, transdermally, subcutaneously and intramuscularly. Opioids exert their actions via the mu opioid receptor, which is located on peripheral nerve terminals, both pre- and post-synaptically in the spinal cord, brainstem, mid-brain and cortical regions associated with sensory and pain processing.

Opioids are known to produce physical dependence, possible addictive behaviors and tolerance with long-term use. In one aspect of the invention, the administration of a controlled substance is effected and monitored using the controlled substance drug delivery system of the invention wherein the controlled substance includes an opioid agonist. There are many types of opioids, including mu-opioid receptor agonists such as endogenous agonists, e.g. beta-endorphin; endomorphins; small peptide agonists, e.g. DAMGO (D-Ala, N-Me-Phe, Gly-ol)-enkephalin or DALDA (H-Dmt-D-Arg-Phe-Lys-NH2); non-peptide agonists, such as morphine, hydromorphone, buprenorphine, oxycodone, tramadol, etorphine, levorphanol, etonitazene and analogues, tilidine and analogues, e.g. the active metabolite nortilidine, loperamide and piritramide; delta-opioid receptor agonists, such as: endogenous agonists, e.g. met-enkephalin (Tyr-Gly-Gly-Phe-Met) and leu-enkephalin (Tyr-Gly-Gly-Phe-Leu); small peptides, e.g. DADLE (D-Ala 2, D-Leu 5) enkephalin or DPDPE (tyrosyl-2,6-3H(N)-(2-D-penicillamine-5-D-penicillamine)-enkephalin); non-peptide agonists, such as BW373U86 (±)-4-(a-R)-a(2S,5R)-4-allyl-2,5-dimethyl-1-piperazinyl)-3-hydroxybenzyl)- N, N-diethylbenzamide or SNC80 (±)-4-(a-R)-a(2S,5R)-4-allyl-2,5-dimethyl-1-piperazinyl)-3-methoxybenzyl)- N, N-diethylbenzamide; kappa-opioid receptor agonists, such as: endogenous agonists, e.g. dynorphin A arylacetamides, e.g. spiradoline (U62, 066), U69,593 ([5alpha,7alpha,8beta]-N-methyl-N-[7-[1-pyrrolidinyl]-1-oxaspiro[4.5]dec8-yl]-benzenacetamide), U50,488, benzomorphans, e.g. cyclazocine, bremazocine, pentazocine, Nalfurafine, salvinorin A; and ORL-A1 receptor agonists, such as: endogenous agonists, e.g. nociceptin; small peptides, e.g. Ro 64-6198 ((1S,3aS)-8-(2,3,3a, 4,5,6-hexahydro-1H-phenalen-1-yl)- 1-phenyl-1,3,8-triaza- spiro[4.5]decan-4-one).

In one aspect of the invention, the administration of a controlled substance is effected and monitored using the controlled substance drug delivery system of the invention and the controlled substance includes a combination of two or more opioid analogues, such as sufentanil plus an opioid such as fentanyl, alfentanil, or remifentanil, or opium alkaloids such as morphine and codeine; semi-synthetic opioids such as heroin and oxycodone; and fully synthetic opioids such as pethidine and methadone, that have structures unrelated to the opium alkaloids.

In alternative embodiments, the controlled substance drug delivery system of the invention is used to deliver at least one opioid drug and one or more other drugs wherein the other drug may be an opioid or non-opioid drug. The non-opioid drug may be added to increase analgesic efficacy or to help deter abuse or to avoid opioid-induced side effects.

Examples of the classes of drugs which could be added to the opioid to increase analgesic efficacy may include but are not limited to: anti-inflammatory drugs, such as non-steroidal anti-inflammatory drugs (including cyclooxygenase inhibitors and lipoxygenase inhibitors), steroid anti-inflammatory drugs, acetaminophen, cytokine antagonists, tumor necrosis factor antagonists, prostaglandin receptor antagonists. Also included are drugs that are analgesic via non-anti-inflammatory mechanisms, such as sodium channel blockers, N-type calcium channel blockers, monoamine uptake inhibitors, n-methyl-d-aspartate receptor antagonists, gamma aminobutyric acid (GABA)-A or GABA-B receptor agonists, or other receptor agonists or antagonists or enzyme inhibitors known by one skilled in the art to be of analgesic benefit.

Examples of drugs added to avoid abuse may include but are not limited to naloxone and naltrexone or other opioid receptor antagonists. Examples of drugs added to reduce opioid-induced side effects may include but are not limited to: anti-pruretic drugs, such as anti-histamines, anti-constipation drugs or gut stimulants, such as metoclopramide, anti-sedation drugs, such as stimulants, (e.g. modafinil) and anti-emetic drugs, such as meclizine or dimenhydrinate.

Opioid antagonists include mu-opioid receptor antagonists such as naltrexone; naloxone; peptide antagonists, e.g. D-Phe-Cys-Tyr-D-Trp-Orn-Thr-Pen-Thr amide beta-funaltrexamine; delta-opioid receptor antagonist such as naltriben and naltrindol; kappa-opioid receptor antagonists such as nor-binaltorphimine and 5′-acetamidinoethylnaltrindole; and ORL-1 receptor antagonists such as Phe1 {Psi} (CH2-NH) Gly2] nociceptin (1-13) NH2 and SB-612111 ((-)-cis-1-Methyl-7-[[4-(2,6-dichlorophenyl)piperidin-1-yl]methyl]-6,7,8,9-tetrahydro-5H-benzocyclohepten-5-ol).

SUBOXONE® delivers transmucosal buprenorphine with naloxone for treatment of addiction. The controlled substance drug delivery system of the invention finds utility in delivery of this drug because patients being treated for addiction would greatly benefit from regulated access to this partial agonist opioid medication and would be able to reduce the number of visits to the addiction specialist's office per month.

Those of skill in the art will appreciate that the drug delivery systems of the current invention provide advantages over current methods by controlling the administration of controlled substances and monitoring the delivery process such that the dose can be optimized for efficacy while reducing side effects and potential for abuse.

Opioids remain the most powerful form of analgesics, however, improved forms are needed, that have minimal side effects, and can be delivered to patients in a manner in which patient use can be easily tracked by the physician.

The present invention provides a mean for insuring that the correct patient receives the medication, that potential drug-drug interactions are detected, that the prescribed dose is adjusted as needed, and that the delivery process is monitored in a manner effective to maximize efficacy while reducing side effects and minimizing the potential for abuse.

There is a continuing, unfilled need for a system for administration of controlled substances that includes a drug delivery device that can accurately deliver a given medication to the correct patient in a manner that is cost-effective, minimizes the risk of error, is resistant to pilferage, is not labor-intensive and minimizes the possibility for abuse. The drug delivery device of the controlled substance administration system of the present invention is easily handled, portable, relatively inexpensive and allows for lock-out to avoid overdosing, is child-proof and has theft-proof safety features. In addition, the system provides for multi-unit dosing, such that days, weeks or more of a given medication can be housed in a single device. The present invention meets that need.

### Exemplary Uses of the Controlled Substance Administration and Monitoring System of the Invention Include the Following

1. Out-patient treatment of a post-operative patient after surgery to treat acute pain (e.g. opioids).

2. Out-patient treatment of a patient with chronic pain.

3. Out-patient treatment of a patient suffering from severe chronic pain of malignant or non-malignant origin who also has episodes of severe breakthrough pain.

4. Treatment and monitoring of a patient with a known or suspected history of substance abuse who presents with severe pain.

5. Treatment and monitoring of a patient requiring controlled drugs to treat anxiety (e.g., benzodiaxepines).

6. Treatment and monitoring of a patient requiring controlled drugs to treat insomnia (e.g. benzodiazepines).

7. Treatment and monitoring of a patient requiring controlled drugs to treat attention deficit/hyperactive disorder (e.g., methylphenidate).

8. Treatment and monitoring of a patient requiring controlled drugs to treat excessive sedation (amphetamines, modafinil).

9. The ability to track controlled substance misuse or abuse by a given patient and detect abuse based on the filling of the same or similar prescriptions at multiple pharmacies.

10. The ability to avoid patient tampering of prescription between physician's office and pharmacy by having a electronic National Database with which to compare the written prescription or to have a direct electronic download of the prescription from the physician's office to the pharmacy.

11. The ability to deter attempts by persons other than the patient to self-administer the controlled substance through the use of biometric or other security systems.

12. The ability to avoid accidental misuse of a controlled medication due to unclear instructions or patient forgetfulness by providing a drug delivery device with an electronic lock-out timer and a patient reminder alert.

13. The ability to regulate dosing frequency remotely based on a patient's parameters, such as pain score, by using the docking system to reprogram the device lock-out time as instructed by the physician's office.

14. The ability to gather dosing information on a pre-set frequency by setting a required docking frequency on the device to alert the physician's office if the patient is either purposefully not docking the device to avoid abuse detection or is not able to dock the device due to a medical emergency, such as a heart attack, stroke or other injury.

15. Electronic and printable graphs of drug dosing over any given time frame to allow the patient chart in a physician office to contain this data.

16. The ability to wean a patient off a drug in a controlled manner by progressively programming the lock-out period for longer time intervals between dosing. This would be used for any drug which promotes physical dependence on the drug and requires a slow, methodical wean to avoid an acute withdrawal reaction.

The present invention is described by reference to the following examples, which are offered by way of illustration and are not intended to limit the invention in any manner. Standard techniques well known in the art or the techniques specifically described below are utilized. Therefore, the description and examples should not be construed as limiting the scope of the invention, which is delineated by the appended description of exemplary embodiments.

### EXAMPLES

For purposes of illustration a few exemplary systems and scenarios for their use are provided below:

### Example 1

### Exemplary Outpatient System for Delivery and Monitoring of Administration of Controlled Substances

A patient is a 46 year-old man who suffers from severe low back pain after three back surgeries. He has a distant history of alcohol abuse and methamphetamine abuse. His pain physician would like to start him on morphine sulfate extended release pills prescribed in a controlled substance delivery device. The prescription is written for 30 mg tablets, one every 8 hours, dispense 90 tablets for a 30-day supply. The lock-out time is set for 8 hours and the device docking frequency is entered as every 24 hours since the patient has a history of drug and alcohol abuse. The physician's nurse enters the patient's identifying information in the National Database of the information network along with the prescription as written by the physician and checks to see if the patient is receiving any other controlled drug that is recorded in the system. The patient brings the prescription to the pharmacy in his home town. The pharmacist notes that the drug is to be delivered with a controlled substance delivery device such as an AcelRx™ device so she enters the National Database and checks to see that the written prescription is the same as the entered data from the physician's office. She fills the proper device with 90 tablets of morphine sulfate ER and docks the device so that the patient identifiers and prescribed drug and dosing parameters (drug, pill number, dosing frequency, docking frequency, etc) can be downloaded to the device. The pharmacist then asks the patient for photo identification and asks the patient to activate the biometric fingerprint pad, or other form of security tracking, such as personal identification number (PIN). The patient purchases a docking station and at this time the device is ready for home use. The patient goes home and when the patient desires to self-administer a dose of the morphine for pain relief using the system of the present invention, he holds the delivery device, and pushes any button to wake the device up from its sleep mode. The device will query the user for a thumbprint reading, PIN or some other means of identification. The patent will be required to provide the identifying information once per day as a default (or on a frequency that can be programmed by the physician). The device queries its internal memory and clock to make sure that the dosage regimen programmed into the device is not being violated by the current usage request. The device then delivers a tablet. Attempts to obtain a tablet before the lock-out time of 8 hours are captured electronically. The patient becomes agitated at waiting 8 hours to take another morphine tablet. He attempts multiple times to delivery another tablet before the 8 hour lock-out time. He then gets frustrated and goes to another pain physician in a nearby town to try to obtain a prescription for Vicodin. This physician also uses the controlled substance administration and monitoring system of the invention and logs into the National Database and sees that the patient just received morphine from a pain physician in another town and enters a few sentences describing the encounter. The National Database records the query by the second doctor even though no drug was prescribed and sends an alert email to the first physician's office. When the patient returns to the first pain physician's office, the device is docked on a docking station and the patient usage information is downloaded into the computer system of the controlled substance administration and monitoring system of the current invention. A graph of the patient's drug usage and attempts shows that the patient tried numerous times to deliver a tablet before the 8 hour lock-out time. Also, the nurses at the office had alerted the physician to the query and message from the second physician. The pain physician confronts the patient with this data and suggests that non-opioid pain treatments will be used since the patient is too high-risk to use opioids reliably. If the physician had not used the controlled substance administration and monitoring system of the current invention, the first physician would not be aware of the misuse of the morphine tablets and the second physician would have prescribed the Vicodin to the patient not knowing that he had just received morphine tablets from another physician. The patient would have used a different pharmacy so even the pharmacy staff would not be aware of the multiple prescriptions for opioids.

### Example 2

The patient is a 78 year-old woman with metastatic breast cancer living alone. She does not want to be admitted to hospice. She is quite forgetful and is suffering with severe pain and shortness of breath from metastatic lesions to her ribs and lungs. Her physician prescribes her oxycodone immediate release for severe breakthrough pain. The dose is 10 mg with a lock-out every 3 hours. The physician is not sure of the patient's mental status and understanding of her directions on how to take the medication. The physician is not concerned about purposeful abuse, so she prescribes a docking frequency of every 12 hours but no biometric or PIN ID frequency. The patient brings the prescription to the pharmacy and they tell her how to plug in the docking station to her telephone line and that the device needs to be placed on the dock every 12 hours or it will alarm. She also puts her finger on the docking station to record pulse and oxygen saturation every 12 hours when she docks the device. One week later there is an alert to the physician's office that the oxygen saturation in this patient is low. The nurse calls the patient at home and the patient sounds quite sedated on the phone and tells the nurse that she has no pain but has been taking the oxycodone every 3 hours because she is afraid of dying in pain. The nurse explains that this frequency may be too often and that it is causing her to have too low of an oxygen level in her blood. She tells the patient to dock the device so that remotely it can be reprogrammed for a lock-out of every 6 hours instead of every 3 hours. The patient has home nasal cannula oxygen for use on an as needed basis and the nurse recommends that she use it for the next 12 hours. Her next docking time shows that her oxygen levels are back to normal.

Without the controlled substance administration and monitoring system of the invention, the patient would have continued to take the opioid tablets every 3 hours because of a misunderstanding, resulting in hypoxia and possibly a cardiac arrest. Since no one is living at home with her it could have been days before this was discovered.

### Example 3

A 24 year-old girl has attention deficit disorder and uses methylphenidate which her physician prescribes using a drug delivery device and the controlled substance administration and monitoring system of the invention. The patient calls the office and leaves a message that she is about to run out of drug early because the pharmacy didn't give her enough but fails to leave any information as to what pharmacy she used to fill the prescription. It is a weekend and the doctor calls the patient back but only gets her voicemail. He logs into the AcelRx™ system and finds the name and pharmacy where the drug was dispensed and sees that only a partial fill of the prescription (75 instead of 90 tablets) was given to the patient due to low drug supply of methylphenidate at that pharmacy. The doctor is leaving town the next day but writes another prescription early and leaves it with the office front desk for the patient to pick-up Monday morning.

Without the system of the invention, the doctor would have wasted time trying to contact the patient for the pharmacy information and then try to contact the pharmacy to verify that a partial prescription fill was indeed performed. Since the physician was leaving town, this may or may not have happened in time for the patient to have received a new prescription. This is a Schedule II drug in the U.S. and therefore it can not be called into the pharmacy over the phone. A doctor's written prescription is needed.

### Example 4

A 53 year-old man has a history of Vicodin addiction and is under the care of a physician who is an addiction specialist. The specialist has switched the patient from Vicodin to buprenorphine/naloxone sublingually (Suboxone) in order to begin a slow taper. The patient has very little self-control and the doctor finds himself having to see the patient every other day to prescribe small quantities of pills or the patient will take all the medication at once and run out days or weeks too early and be in massive withdrawal. Instead the physician decides to use the controlled substance administration and monitoring system of the invention to provide controlled delivery of the medication. He can now write a prescription for a full month of medication, 2 mg tablets starting with 8 tablets per day the first week, followed by a taper of one tablet every week for a total of 8 weeks. The patient will dock the device every day so that the physician can check on his usage and once a week the physician will download a new pill number to be delivered per day to continue the weaning process. After the first month, the patient will return to the physician's office for the last month supply and a graph of the first month usage will be placed in the patient's chart.

Without the system of the invention, the patient and the physician would have to have met every few days for two months with a huge cost in time and money to the health care system and/or the patient. Also the patient would not be able to travel or go out of town for two months.

Although the foregoing invention has been described in some detail by way of illustration and example for purposes of clarity and understanding, it will be apparent to those skilled in the art that certain changes and modifications may be practiced. Various aspects of the invention have been achieved by a series of experiments, some of which are described by way of the following non-limiting examples. Therefore, the description and examples should not be construed as limiting the scope of the invention, which is delineated by the appended description of exemplary embodiments.

What is claimed is:

1. A computer aided system for delivery and monitoring delivery of a controlled substance to a patient, comprising:
(a) an information network comprising a computing platform and software comprising a search mechanism running on said computing platform;
(b) at least one information storage device connectable to said computing platform for storing said software;
(c) one or more databases for storing patient usage information and prescription information for at least one controlled substance;
(d) at least one device for administering a controlled substance to a patient connectable to said information network for transmission of patient usage information to said information network; and
(e) a communications interface for establishing a bidirectional communication link to at least one external source.

2. The system according to claim 1, wherein said prescription information comprises information regarding said patient and is stored in a national database of controlled substance users.

3. The system according to claim 2, wherein said national database of controlled substance users is in compliance with Health Insurance Portability and Accountability Act (HIPAA) regulations.

4. The system according to claim 2, wherein said national database of controlled substance users provides coded or encrypted patient information to avoid misuse of information or inappropriate access.

5. The system according to claim 2, wherein said prescription information for at least one controlled substance comprises a prescription for a controlled substance issued by a prescribing physician and said prescription information is entered into said information network by a registered user.

6. The system according to claim 1, wherein said system further comprises a software generated alert when a search of said national database indicates that prescription information for more than one controlled substance has been entered into said national database for the same patient during the same time period.

7. The system according to claim 6, wherein said software generated alert is transmitted to said prescribing physician and said registered user.

8. The system according to claim 1, wherein said system further comprises a software generated alert when a search of said national database indicates the possibility of a drug-drug interaction and said alert is transmitted to said prescribing physician and said registered user.

9. The system according to claim 1 wherein said at least one device is connected to said information network by way of a docking station and patient usage information is transmitted to said information network and stored in at least one database.

10. The system according to claim 1, wherein said docking station is connected to the information network by way of connection selected from the group consisting of a computer, removable card (or other media), a phone line, a wireless connection and a USB port.

11. The system according to claim 9, wherein said at least one device for administering a controlled substance comprises a detection mechanism for patient identification.

12. The system according to claim 11, wherein said detection mechanism for patient identification is a biometric indicator selected from the group consisting of an RFID tag, a password, a pass code, fingerprint information, optical information, voice recognition, facial recognition and DNA analysis of a bodily fluid sample.

13. The system according to claim 1, further comprising at least one input device for manually entering information into said system for delivery and monitoring delivery of controlled substances.

14. The system according to claim 13, wherein said at least one input device is a microphone, a touch screen, a keyboard, or a graphical input device.

15. The system according to claim 5, wherein said prescribed controlled substance is loaded into said at least one device at a physician's office.

16. The system according to claim 5, wherein said prescribed controlled substance is loaded into said at least one device at a pharmacy.

17. The system according to claim 1, further comprising a visual display device for displaying patient usage information.

18. The system according to claim 1, wherein information is transmitted to, form or within said system by a communication means selected from the group consisting of a telephone, an Internet connection, a WAN network connection, a LAN network connection, a wireless connection and a satellite connection.

19. The system according to claim 1, wherein said at least one database stores patient usage information and said system further comprises at least one output device which outputs said patient usage information stored in said database.

20. A method for delivery and monitoring of administration of a controlled substance to a patient, comprising, providing a computer aided system for delivery and monitoring administration of a controlled substance to a patient according to claim 1, comprising the steps of:
(a) issuance of a prescription for a controlled substance by a physician; and
(b) input of prescription information regarding said prescription and said patient into said an information network via bidirectional communication,
wherein said system software conducts a search of said one or more databases to determine if more than one controlled substance prescription issued by a prescribing physician has been filled for said patient during the same time period and a system generated alert is issued if said software determines that more than one controlled substance prescription has been dispensed for said patient during the same time period.

21. The method according to claim 20, further comprising a system generated alert, said alert transmitted to said prescribing physician and said registered user when said software determines that more than one controlled substance prescription has been dispensed for said patient during the same time period.

22. The method according to claim 21, wherein a system generated alert is transmitted to said prescribing physician and said registered user by communication selected from the group consisting of an email, a text message, a page, a phone call or other communication.

23. The method according to claim 22, further comprising input of changes to said prescription information for at least one controlled substance into said information network by a registered user.

24. The method according to claim 20, further comprising said system software conducting a search of said one or more databases to determine if dispensing of said controlled substance might result in a drug/drug interaction.

25. The method according to claim 24, wherein a system generated alert is transmitted to said prescribing physician and said registered user when said software determines that a drug/drug interaction is possible.

26. The method according to claim 25, wherein a system generated alert is transmitted to said prescribing physician and said registered user by communication selected from the group consisting of an email, a text message, a page, a phone call or other communication.

27. The method according to claim 20, further comprising loading of at least one controlled substance into said at least one device for administering a controlled substance and dispensing said loaded device to a patient when no alert is generated by said system.

28. The method according to claim 27, further comprising verifying said patient identity and activating said drug delivery device once said verification is complete.

29. The method according to claim 28, further comprising self-administration of said controlled substance by said patient with said activated drug delivery device.

30. The method according to claim 20, further comprising storage of said prescription information and information regarding said patient in a national database of controlled substance users.

31. The method according to claim 30, wherein said national database of controlled substance users is in compliance with Health Insurance Portability and Accountability Act (HIPAA) regulations.

32. The method according to claim 30, wherein said national database of controlled substance users provides coded or encrypted patient information to avoid misuse of information or inappropriate access.

33. The method according to claim 20, further comprising connection of said at least one device for administering a controlled substance to said information network by way of a docking station, wherein patient usage information is transmitted to said information network via said docking station.

34. The method according to claim 33, wherein said docking station wherein is connected to the information network by way of connection selected from the group consisting of a computer, removable card (or other media), a phone line, a wireless connection and a USB port.

35. The method according to claim 20, further comprising storage of said patient usage information in said one or more databases.

36. The method according to claim 27, wherein said at least one device for administering a controlled substance comprises a detection mechanism for verifying patient identity.

37. The method according to claim 36, wherein said detection mechanism for verifying patient identity is selected from the group consisting of an RFID tag, a password, a pass code, fingerprint information, optical iris information, voice recognition, facial recognition and DNA analysis of a bodily fluid sample.

38. The method according to claim 36, further comprising verifying patient identity on a daily basis.

39. The method according to claim 36, further comprising verifying patient identity on a weekly basis.

40. The method according to claim 36, further comprising verifying patient identity on a monthly basis.

41. The method according to claim 20, further comprising manually entering information into said system for delivery and monitoring delivery of controlled substances using at least one input device.

42. The method according to claim 41, wherein said at least one input device is a microphone, a touch screen, a keyboard or a graphical input device.

43. The method according to claim 20, further comprising loading said controlled substance into said at least one device for administering a controlled substance at a physician's office.

44. The method according to claim 20, further comprising loading said controlled substance into said at least one device for administering a controlled substance at a pharmacy.

45. The method according to claim 20, wherein said system comprises at least one visual display device, further comprising, displaying on said at least one visual display patient usage information.

46. The method according to claim 20, further comprising, collecting information on biological parameters of said patient by way of said docking station.

47. The method according to claim 46, wherein information on biological parameters of said patient is information selected from the group consisting of pain score, anxiety score, insomnia score, temperature, pulse, blood pressure, respiratory rate, oxygen saturation, blood chemistry and bodily fluid chemistry.

48. The method according to claim 33, further comprising:
review of said transmitted patient usage information to assist qualified health care personnel in verifying or adjusting a controlled substance prescription.

49. The method according to claim 33, further comprising the step of:
input of changes to said controlled substance prescription information of the patient by a registered user wherein said changed prescription information is transmitted to said information network.

50. The method according to claim 49, further comprising the step of:
docking said at least one device for administering a controlled substance wherein said changed prescription information is transmitted to said device.

51. The method according to claim 49, wherein said input is in response to an alert.

52. The method according to claim 49, wherein said input is in response to information obtained from docking said drug delivery device.

53. A method according to claim 33, wherein information obtained from docking said drug delivery device is displayed visually on at least one visual display device.

54. The method according to claim 53, wherein said patient usage information comprises dosing frequency and number of dosage unties remaining in the device.

55. A method according to claim 20, wherein information is transmitted to, from or within said system by a communication means selected from the group consisting of a telephone, an Internet connection, a WAN network connection, a LAN network connection, a wireless connection and a satellite connection.
